(19) United States
(12) Patent Application Publication
(10) Pub. No.: US 2021/0331512 A1
(43) Pub. Date: Oct. 28, 2021

(54) BINDER CLIP

(71) Applicant: Jaekook CHUNG, Seoul (KR)

(72) Inventor: Jaekook CHUNG, Seoul (KR)

(21) Appl. No.: 17/010,268

(22) Filed: Sep. 2, 2020

(30) Foreign Application Priority Data
Apr. 27, 2020 (KR) 10-2020-0050610

(51) Int. Cl. B42F 1/00; B42F 1/06

(52) U.S. Cl. CPC B42F 1/006; B42F 1/06

(57) ABSTRACT

Disclosed herein is a binder clip. The binder clip includes: a body formed by integrating an elastic plate and clamping surfaces with one another, and provided with fastening portions; first and second grips each coupled to both sides of each of the clamping surfaces of the body, and configured to open the fastening portions; first and second rotatable hinges rotatably disposed around ends of the first and second grips; first and second supports each coupled and fastened to a corresponding one of the first and second rotatable hinges, and configured to have a round bar shape and a same torque; and a socket provided with a connection hole configured such that second ends of the first and second supports are fastened into both sides thereof and are connected to the socket, and configured to have the same torque and rotational threads on the inner surface of the connection hole.

### CROSS-REFERENCE TO RELATED APPLICATION

This application claims the benefit of Korean Patent Application No. 10-2020-0050610 filed on Apr. 27, 2020, which is hereby incorporated by reference herein in its entirety.

### BACKGROUND

### 1. Technical Field

The present invention relates generally to a binder clip, and more particularly to a binder clip in which threaded rods are installed on two grips, respectively, the two threaded rods are connected via a single socket, and the binder clip is selectively opened and closed using the distance between the threaded rods that is adjusted by the rotation of the socket.

### 2. Description of the Related Art

Binder clips are widely used for the purpose of temporarily collecting, holding, and easily sorting documents. In particular, a binder clip that holds multiple documents at once in an office has the advantage of storing a large number of documents without damaging the documents, unlike a clip or stapler.

In general, a binder clip includes a body and two grips. When a user applies pressure to the two grips, the fastening portions of the body are opened according to the principle of the lever and hold documents. In this case, the binder clip is made of materials, such as metal, plastic, high-strength synthetic resin, wood, etc. The binder clip is used in such a manner that documents are held and fastened by the two grips and the grips are turned over in a fastening direction. The binder clip is mainly used to store multiple documents at once without damaging the documents.

However, the binder clip is configured to open the fastening portions of the body by applying pressure to the two grips using the principle of the lever. Accordingly, a problem arises in that a large amount of pressure needs to be applied to the two grips in order to open the fastening portions wide to grip thick documents. Accordingly, a large amount of force is required to pick up and fasten thick documents using the binder clip.

In order to solve this problem, a binder clip is configured to allow the distance between a point of effort and a fulcrum to be kept long by increasing the length of two grips to reduce the amount of pressure to be applied to the two grips. For reference, the point of effort corresponds to the ends of the two handles to which a user applies pressure, and the fulcrum corresponds to the point that supports the two grips in the middle of the point of effort and the fulcrum.

Accordingly, when the size of the binder clip is increased, the grips serving as a lever become excessively long, and thus a problem arises in that it is impossible to fabricate a binder clip having a certain size or more. In other words, documents thicker than the maximum griping thickness of the binder clip are generally punched and stored in a document binder. However, the document binder has a problem in that the use of space is inefficient due to the volume of the binder itself.

### PRIOR ART DOCUMENTS

### Patent Documents

Patent document 1: Korean Patent Application Publication No. 10-2014-0102829 (published on Aug. 25, 2014)

Patent document 2: Korean Utility Model Application Publication No. 20-2010-0001454 (published on Feb. 10, 2010)

### SUMMARY

The present invention has been conceived to overcome the above-described problems, and an object of the present invention is to provide a binder clip in which threaded rods are installed on two grips, respectively, the two threaded rods are connected via a single socket, and the binder clip is selectively opened and closed using the distance between the threaded rods that is adjusted by the rotation of the socket.

An object of the present invention is to provide a binder clip that can be applied to and efficiently store a number of documents equal to the number of documents that can be held by a single binder.

An object of the present invention is to provide a binder clip that can be easily and selectively opened and closed without requiring a large amount of force while allowing the grips thereof to be kept short.

The objects of the present invention are not limited to the objects mentioned above, and other objects and advantages of the present invention that are not mentioned can be understood from the following description, and will be more clearly understood by embodiments of the present invention. Furthermore, it will be easily understood that the objects and advantages of the present invention can be realized by the means shown in the claims and combinations thereof.

In order to accomplish the above objects, the present invention provides a binder clip including: a body formed by integrating an elastic plate and clamping surfaces with one another, and provided with fastening portions configured to be selectively opened and closed by the elastic force of the elastic plate at ends of the clamping surfaces; first and second grips each coupled to both sides of each of the clamping surfaces of the body, and configured to open the fastening portions by using the elastic plate as a fulcrum according to the principle of the lever by means of a pressure applied inward; first and second rotatable hinges rotatably disposed around ends of the first and second grips corresponding to a point of effort; first and second supports each coupled and fastened to a corresponding one of the first and second rotatable hinges at one side end thereof, and configured to have a round bar shape and a same torque and rotational threads in opposite directions on outer surfaces thereof; and a socket provided with a connection hole configured such that second ends of the first and second supports are fastened into both sides thereof and are connected to the socket, and configured to have the same torque and the same rotational threads on the inner surface of the connection hole so that when the socket is rotated, at least one of the first and second supports fastened into the connection hole is inserted or projected depending on the rotational direction of the threads.

The second ends of the first and second supports may be spaced apart from each other by a predetermined distance on a rectilinear line.

The first and second grips may be formed in a V shape in which an end of each of the grips has a predetermined length, and may allow the first and second rotatable hinges to be located at one point of the apex of the V shape.

The socket may be configured such that a distance from the center thereof is increased by protruding the corners of the outer surfaces thereof in curved surface shapes.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram showing the configuration of a binder clip according to an embodiment of the present invention;

FIGS. 2A and 2B are diagrams showing the shapes of the grips shown in FIG. 1;

FIG. 3 is a diagram showing the configuration of the first and second supports shown in FIG. 1; and

FIGS. 4A, 4B and 4C are sectional views showing the configurations of the socket shown in FIG. 1.

### DETAILED DESCRIPTION

Other objects, features and advantages of the present invention will become apparent through a detailed description of embodiments taken with reference to the accompanying drawings.

Although the terms used in the present invention have been selected from general ones currently widely used in the art while considering their functions in the present invention, they may vary depending on the intention of a technician working in the art, a precedent, the advent of new technology, or the like. Furthermore, in specific cases, some terms have been selected by the applicant as needed, in which case their meanings will be described in detail in the relevant portions of the following description. Accordingly, the terms used in the present invention should be defined based on the meanings of the terms and the overall contents of the terms in the present invention, not the simple names of the terms.

Embodiments of a binder clip according to the present invention will be described with reference to the accompanying drawings. However, the present invention is not limited to the embodiments disclosed below, but may be implemented in various different forms. The embodiments are provided merely to complete the disclosure of the present invention and to fully inform a person skilled in the art of the scope of the invention. Therefore, the embodiments described in the present specification and the configurations shown in the drawings are only the most preferred embodiments of the present invention, and do not represent the overall technical spirit of the present invention. Accordingly, it should be understood that there may be various equivalents and modifications that may be substituted for them at the time when the present application is filed.

In the following description, the passage “a component is disposed above (below) another component or over (beneath) another component” means not only that the former component may be disposed on the top surface (or the bottom surface) of the latter component, but also that a third component may be interposed between the former component and the latter component disposed over (beneath) the former component.

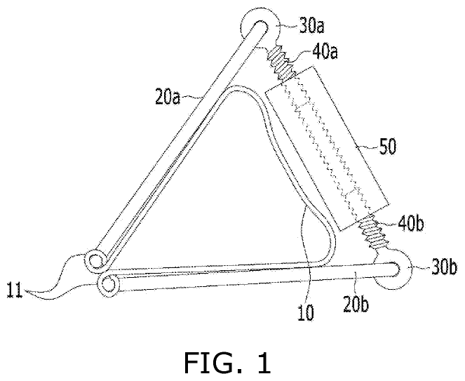

FIG. 1 is a diagram showing the configuration of a binder clip according to an embodiment of the present invention. The binder clip shown in FIG. 1 is based on one embodiment. The components of the binder clip are not limited to the embodiment shown in FIG. 1, and some components may be added, changed, or deleted as necessary.

As shown in FIG. 1, the binder clip according to the present invention may include a body 10, first and second grips 20a and 20b, first and second rotatable hinges 30a and 30b, first and second supports 40a and 40b, and a socket 50. In this case, the first and second rotatable hinges 30a and 30b and the first and second supports 40a and 40b may be composed of one integrated member. However, for ease of description, the first and second rotatable hinges 30a and 30b and the first and second supports 40a and 40b will be described as being separate.

The body 10 may be formed by integrating an elastic plate and clamping surfaces with one another, and may include fastening portions 11 configured to be selectively opened and closed by the elastic force of the elastic plate at ends of the clamping surfaces. In this case, the clamping surfaces are formed to extend from both sides of the elastic plate, and are located such that the fastening portions 11 located at the ends of the clamping surfaces are brought into contact with each other by the elastic force of the elastic plate. Accordingly, the side surface of the body 10 may maintain a triangular shape.

The first and second grips 20a and 20b may be each coupled to both sides of each of the clamping surfaces of the body 10, and may open the fastening portions 11 by using the elastic plate as a fulcrum according to the principle of the lever by means of the pressure applied inward. In this case, the first ends of the first and second grips 20a and 20b may be fastened to the fastening portions 11 so that the first and second grips 20a and 20b can be rotated vertically.

Furthermore, the first and second grips 20a and 20b may be configured such that the second ends thereof protrude in the directions of the clamping surfaces past the elastic plate of the body 10.

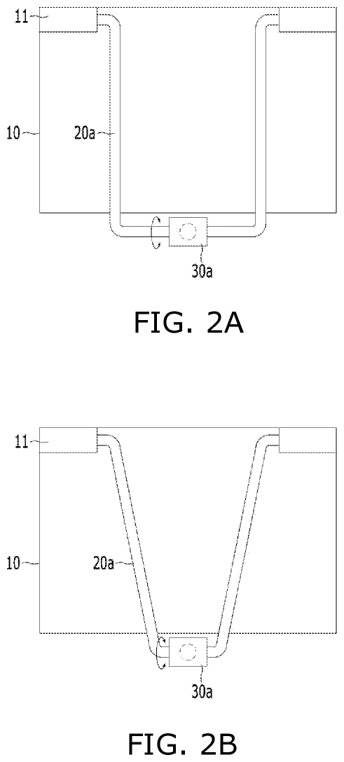

FIGS. 2A and 2B are diagrams showing embodiments of the shapes of the grips shown in FIG. 1.

As shown in FIG. 2A, the first and second grips 20a and 20b may be formed in a “U” shape in which an end of each of the grips has a predetermined length. However, the shape of the first and second grips 20a and 20b is not limited thereto. As shown in FIG. 2B, the first and second grips 20a and 20b may be formed in a “V” shape in which an end of each of the grips has a predetermined length.

In this case, when the first and second grips 20a and 20b are formed in a “V” shape, each of the first and second rotatable hinges 30a and 30b disposed around the ends of the grips may be located at one point, and thus the pressure applied inward is concentrated in one place without being distributed, so that a strong pressure may be provided with a small force.

The first and second rotatable hinges 30a and 30b may be rotatably disposed around ends of the first and second grips 20a and 20b corresponding to a point of effort. In this case, the point of effort of the first and second grips 20a and 20b may correspond to the center of the second ends opposite to the ends of the first and second grips 20a and 20b coupled to the fastening portions 11.

Meanwhile, although the first and second rotatable hinges 30a and 30b are each formed in a circular coin shape having a predetermined thickness, as shown in FIG. 1, the configuration thereof is not limited thereto, but may be formed in various shapes.

One side end of each of the first and second supports 40a and 40b may be coupled and fastened to each of the first and second rotatable hinges 30a and 30b. Furthermore, the first and second supports 40a and 40b may have a round bar shape, and may include the same torque and rotational threads in opposite directions on the outer surfaces thereof.

As an example, the first support 40a may include rotational threads in a clockwise direction, and the second support 40b may include rotational threads in a counterclockwise direction.

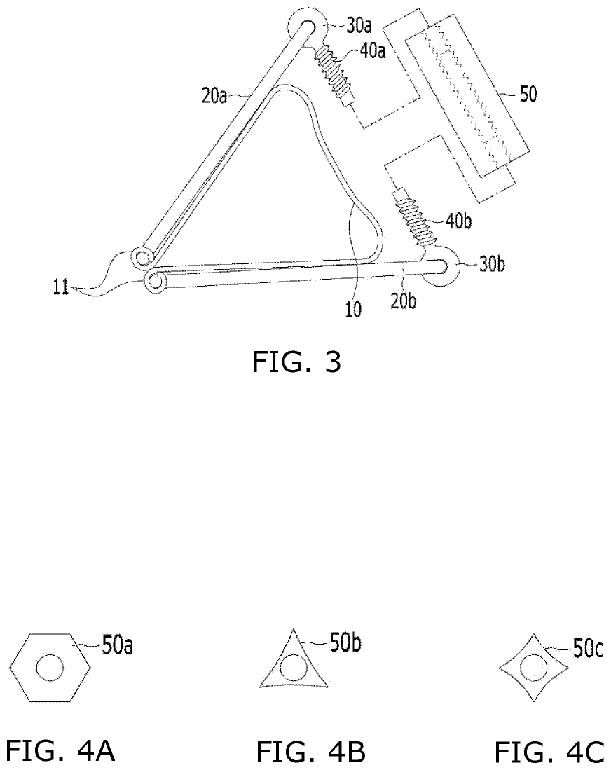

FIG. 3 is a diagram showing the configuration of the first and second supports shown in FIG. 1, and shows a configuration in which the first support 40a and the socket 50 are separated from each other.

As shown in FIG. 3, the first and second supports 40a and 40b may be configured such that the second ends thereof are spaced apart from each other by a predetermined distance on a straight line. In other words, the first ends of the first and second supports 40a and 40b may be coupled and fastened to the first and second rotary hinges 30a and 30b, respectively, and the second ends of the first and second supports 40a and 40b may be configured to be spaced apart from each other by a certain distance on a straight line.

In this case, the fastening portions 11 of the body 10 are opened in proportion to the distance between the first and second grips 20a and 20b based on the fulcrum of the elastic plate according to the principle of the lever. For reference, the fulcrum of the elastic plate corresponds to one point of the elastic plate that supports both the grips in the middle of a point of effort and the fastening portions.

Accordingly, as the protruding length of the first and second grips 20a and 20b protruding in the directions of the clamping surfaces past the elastic plate of the body 10 decreases, the distance by which the fastening portions 11 of the body 10 are opened and closed may become longer than the distance by which the first and second supports 40a and 40b are moved vertically.

Accordingly, even when the distance by which the first and second supports 40a and 40b are spaced apart from each other is shorter than the height of the elastic plate of the body 10, the fastening portions 11 may be opened wider than the height of the elastic plate.

However, as the length by which the first and second grips 20a and 20b protrude decreases, the force required to rotate the socket 50 increases. In order to overcome this problem, only any one of the first and second supports 40a and 40b coupled to both side ends of the socket 50 may include rotational threads.

In other words, as the socket 50 is rotated, pressure is applied to the first and second grips 20a and 20b in an inward or outward direction depending on the rotational threads provided on the outer surfaces of the first and second supports 40a and 40b, and thus the fastening portions 11 of the body 10 are selectively opened or closed.

In this case, in the case where only the first support 40a has rotational threads and the remaining second support 40b does not have rotational threads and has only empty grooves, when the socket 50 is rotated, only the first support 40a may pull or push the first grip 20a in an inward or outward direction depending on the rotational threads. This may reduce pressure compared to the pressure in the case of pulling or pushing both the first and second grips 20a and 20b, thereby providing the effect of reducing the force required to rotate the socket 50.

The socket 50 may include a connection hole configured such that the second ends of the first and second supports 40a and 40b are fastened into both sides thereof and are connected to the socket 50. Furthermore, the inner surface of the hole may include the same torque and the same rotational threads. In this case, the torque is preferably the same as the torque of the rotating threads provided on the outer surfaces of the first and second supports 40a and 40b.

Furthermore, when the socket 50 is rotated, the first and second supports 40a and 40b fastened into the connection hole may be inserted inward or projected to the outside depending on the rotational direction of the threads.

In this case, the rotational threads provided on the outer surfaces of the first and second supports 40a and 40b have opposite directions. Accordingly, as the socket 50 is rotated in one direction, the first and second supports 40a and 40b fastened into both sides of the connection hole are inserted or projected in the same manner.

As an example, in the case where the first support 40a has rotational threads having a clockwise direction and the second support 40b has rotational threads having a counterclockwise direction, when the socket 50 is rotated in the counterclockwise direction, the first and second supports 40a and 40b are inserted into the connection hole. In contrast, when the socket 50 is rotated in the clockwise direction, the first and second supports 40a and 40b are projected out of the connection hole.

FIGS. 4A, 4B and 4C are sectional views showing the configurations of the socket shown in FIG. 1.

As shown in FIG. 4A, a socket 50a includes outer surfaces having a hexagonal sectional shape.

However, when the outer surface of the socket part 50a is formed to have a hexagonal sectional shape, it may be difficult for a user to sufficiently apply force when rotating the socket 50 with fingers. Accordingly, as shown in FIGS. 4B and 4C, sockets 50b and 50c may have outer surfaces having a triangular or square sectional shape.

When the outer surfaces of the sockets 50b and 50c have a triangular or square sectional shape and are formed as internally concave curved surfaces, the corners of the outer surfaces of the sockets 50b and 50c protrude in a sharp, curved shape, and thus the outer surfaces of the sockets 50b and 50c are formed in a shape that is easy to receive a user's force. Furthermore, torsion moment (torque) may be increased by increasing the distance from the center. In other words, when torsion moment torque is increased, a user may more easily rotate the sockets 50b and 50c. However, the shape of the outer surfaces of the socket 50 is not limited thereto, but may be formed in various shapes that allow sufficient force to be applied when a user rotates the socket 50.

In this case, the socket 50 may be rotated using a dedicated spanner or the like when necessary.

The binder clip according to the present invention may open the fastening portions 11 through the rotation of the socket 50 without opening the fastening portions 11 in such a manner that a user directly holds the first and second grips 20a and 20b and applies pressure in an inward direction.

Through this configuration, the length by which the first and second grips 20a and 20b protrude in the directions of the clamping surfaces past the elastic plate of the body 10 may be minimized, and thus binder clips having a size larger than those of conventional binder clips may be fabricated. In other words, it may be possible to increase the size of a binder clip while reducing the length of both the grips by minimizing the grips.

The binder clip according to the present invention, which has been described above, has the following effects:

First, there is achieved the effect of increasing the size of the binder clip while allowing the length of the two grips to be kept short by minimizing the grips by means of the method using threaded rods and a socket.

Second, there is achieved the effect of enabling the binder clip to be applied to a number of documents equal to the number of documents that can be held by a binder, thereby eliminating the use of space attributable to the volume of the binder itself and thus enabling the efficient storage of documents.

Third, there is achieved the effect of easily and selectively opening and closing the binder clip without requiring a large amount of force while allowing the grips of the binder clip to be kept short.

In addition to these above-described effects, the specific effects of the present invention have been described when specific details for carrying out the present invention have been described above.

Meanwhile, in the devices according to the disclosed embodiments, all documents including publications, patent applications, patents, etc. cited in the disclosed embodiments may be incorporated into the disclosed embodiments in the same manner as shown below, as indicated by merging individual cited documents individually and specifically or by merging individual cited documents as a whole.

In order to help to understand the disclosed embodiments, reference symbols have been used in the preferred embodiments shown in the drawings, and specific terms have been used to describe the disclosed embodiments. The disclosed embodiments are not limited by the specific terms, and the disclosed embodiments may include all the components that are commonly conceived by those skilled in the art.

Specific implementations described in the disclosed embodiments are merely examples, and do not limit the scope of the present invention in any way. Furthermore, the connections of lines or connection members between the components shown in the drawings exemplarily represent functional connections and/or physical or circuit connections. In actual devices, these may be represented by various functional, physical or circuit connections that can be replaced or added. In addition, unless there is a specific reference, such as “essential,” “important,” or the like, for a component in question, it may not be an essential component for application of the disclosed embodiment. Furthermore, it will be easily understood by those having ordinary skill in the art to which the present invention pertains that various embodiments may be made within the scope or technical spirit of the present invention. Therefore, the true scope of technical protection of the present invention should be determined by the technical spirit of the appended claims.

What is claimed is:

1. A binder clip comprising:
a body formed by integrating an elastic plate and clamping surfaces with one another, and provided with fastening portions configured to be selectively opened and closed by an elastic force of the elastic plate at ends of the clamping surfaces;
first and second grips each coupled to both sides of each of the clamping surfaces of the body, and configured to open the fastening portions by using the elastic plate as a fulcrum according to a principle of a lever by means of a pressure applied inward;
first and second rotatable hinges rotatably disposed around ends of the first and second grips corresponding to a point of effort;
first and second supports each coupled and fastened to a corresponding one of the first and second rotatable hinges at one side end thereof, and configured to have a round bar shape and a same torque and rotational threads in opposite directions on outer surfaces thereof; and
a socket provided with a connection hole configured such that second ends of the first and second supports are fastened into both sides thereof and are connected to the socket, and configured to have a same torque and same rotational threads on an inner surface of the connection hole so that when the socket is rotated, at least one of the first and second supports fastened into the connection hole is inserted or projected depending on a rotational direction of the threads.

2. The binder clip of claim 1, wherein second ends of the first and second supports are spaced apart from each other by a predetermined distance on a rectilinear line.

3. The binder clip of claim 1, wherein the first and second grips are formed in a V shape in which an end of each of the grips has a predetermined length, and allow the first and second rotatable hinges to be located at one point of an apex of the V shape.

4. The binder clip of claim 1, wherein the socket is configured such that a distance from a center thereof is increased by protruding corners of outer surfaces thereof in a curved surface shape.
